(19) United States
(12) Patent Application Publication
(10) Pub. No.: US 2020/0016772 A1
(43) Pub. Date: Jan. 16, 2020

(54) HAND CONNECTION POSITION VARIABLE DEVICE AND ROBOT

(71) Applicant: Fanuc Corporation, Yamanashi (JP)

(72) Inventor: Yoshio Motowaki, Minamitsuru-gun (JP)

(73) Assignee: Fanuc Corporation, Yamanashi (JP)

(21) Appl. No.: 16/446,673

(22) Filed: Jun. 20, 2019

(30) Foreign Application Priority Data
Jul. 11, 2018 (JP) 2018-131555

(51) Int. Cl. B25J 15/04; B25J 17/02

(52) U.S. Cl. CPC B25J 15/0433; B25J 17/02

(57) ABSTRACT

A hand connection position variable device capable of easily avoiding interference between a robot and a surrounding object, etc., and a robot provided with the device. The hand connection position variable device includes an adapter attached to a wrist, a hand configured to hold a tool that allows the robot to perform a predetermined task, a positioning mechanism configured to be capable of positioning, relative to the adapter, the hand in any of a plurality of positions including a first position and a second position that has at least one of a position and an orientation of the tool relative to the adapter being different from that of the first position, and an attaching/detaching mechanism configured to detachably hold the hand relative to the adapter.

### BACKGROUND OF THE INVENTION

### 1. Field of the Invention

The present invention relates to a hand connection position variable device capable of varying a connection position of a hand to a robot and relates to a robot provided with the device.

### 2. Description of the Related Art

As a mechanism for positioning and attaching a tool adapter to a tip of a robot arm, a mechanism that uses a pin or a rod is known (e.g., refer to JP S63-150180 A, JP S63-300885 A, and JP H08-011075 A). Additionally, an automatic tool changer (ATC) for automatically replacing a tool is known (e.g., refer to JP H09-168989 A).

With the use of an ATC, etc., various types of hands can be alternatively attached to a single robot, allowing the robot to be used for multiple applications. However, since hands (tools), which are high in price, generally need to be prepared for each application, the cost of equipment, including robots, has been expensive. For example, in an application where a tip of a hand such as a welding hand, a soldering hand, or a dispenser hand needs to be introduced into a relatively narrow space, a base of the hand, a robot arm, or a fitting thereof may interfere with a surrounding object, etc. In such a case, it is necessary to prepare another hand that does not result in interference or change in the design of the interfering object, such as the surrounding object. Thus, a structure that can easily avoid interference with the robot, the surrounding object, etc., is desired so that the robot can be used for many applications with as few types of hands as possible.

### SUMMARY OF THE INVENTION

One aspect of the present disclosure is a hand connection position variable device comprising: an adapter attached to a movable part of a robot; a hand configured to hold a tool configured to allow the robot to perform a predetermined task; a positioning mechanism configured to be capable of positioning, relative to the adapter, the hand in any of a plurality of positions including a first position and a second position that has at least one of a position and an orientation of the tool relative to the adapter being different from that of the first position; and an attaching/detaching mechanism configured to detachably hold, relative to the adapter, the hand positioned by the positioning mechanism.

Another aspect of the present disclosure is a robot comprising: the above-described hand connection position variable device and the movable part.

### BRIEF DESCRIPTION OF THE DRAWINGS

The above and other objects, features and advantages of the present invention will be made more apparent by the following description of the preferred embodiments thereof with reference to the accompanying drawings wherein:

FIG. 1 is a diagram illustrating an example of a configuration of a robot provided with a hand connection position variable device according to a preferred embodiment;

FIG. 2 is a diagram illustrating an example of a configuration of the hand connection position variable device;

FIG. 3 is a diagram of the hand connection position variable device as viewed from an angle different from that of FIG. 2;

FIG. 4 is a diagram of a hand of the hand connection position variable device as viewed from above;

FIG. 5 is an enlarged view of the hand connection position variable device in FIG. 1;

FIG. 6 is a diagram illustrating an adapter rotated from the state in FIG. 5;

FIG. 7 is a diagram of the hand connection position variable device as viewed from the same angle as in FIG. 3 but illustrates an example with a position and an orientation of a tool relative to the adapter being different from those in FIG. 3;

FIG. 8 is a diagram of the hand connection position variable device as viewed from the same angle as in FIG. 3 but illustrates an example with the position and the orientation of the tool relative to the adapter being different from those in FIG. 3 and FIG. 7;

FIG. 9 is a diagram illustrating another specific example of the hand;

FIG. 10 is a diagram illustrating the hand in FIG. 9 attached to the adapter;

FIG. 11 is a diagram illustrating an example of an application of the robot when the hand in FIG. 9 is used; and

FIG. 12 is an explanatory drawing illustrating interference of the robot and avoidance of rack interference in the application in FIG. 11.

### DETAILED DESCRIPTION

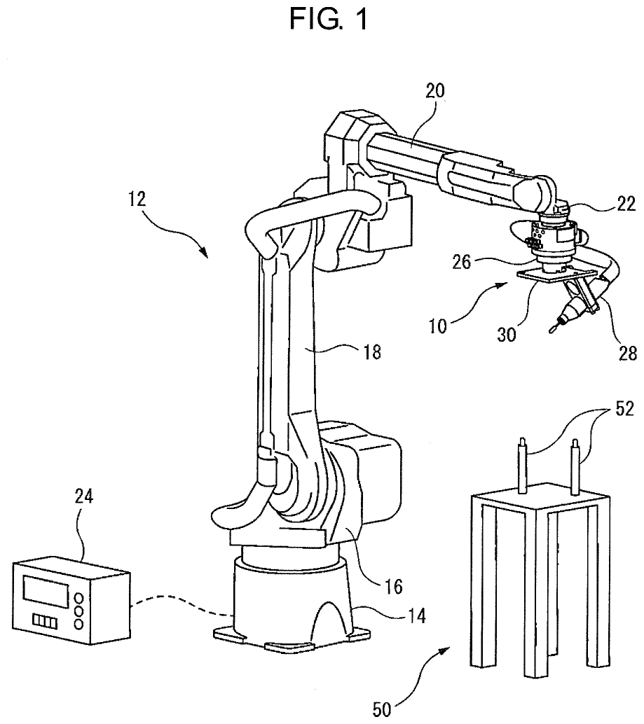

FIG. 1 illustrates an example of a configuration of a robot 12 provided with a hand connection position variable device 10 according to a preferred embodiment. The robot 12 may have any structure as long as the robot 12 includes a movable part (robot arm) capable of performing an operation described later. In the illustrated example, the robot 12 is a six-axes articulated robot including a base 14, a turning body 16 capable of turning about an axis line in a substantially vertical direction relative to the base 14, an upper arm 18 rotatably attached to the turning body 16, a forearm 20 rotatably attached to the upper arm 18, and a wrist 22 rotatably attached to the forearm 20.

A robot controller 24 including an arithmetic processing device, a memory, etc., for controlling the robot 12 is connected to the robot 12, and the operation of the robot 12 described later can also be controlled by the robot controller 24.

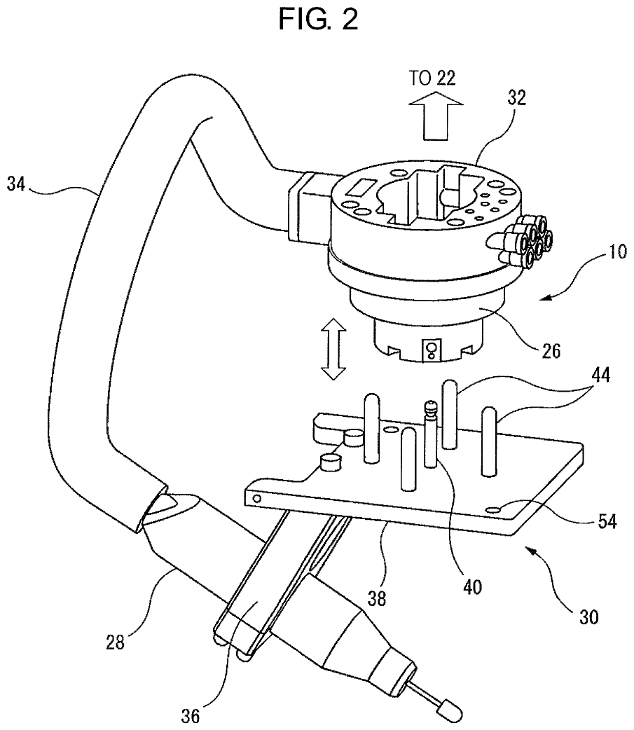

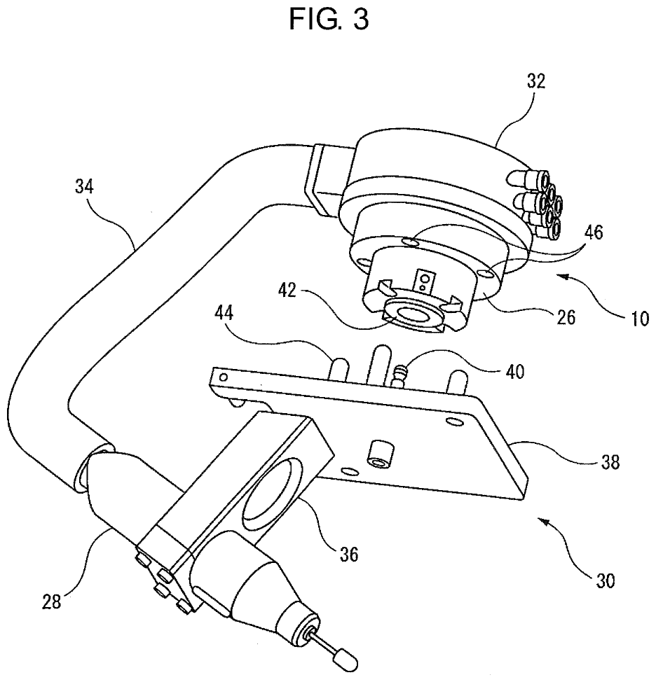

FIG. 2 is a diagram illustrating an example of a configuration of the hand connection position variable device 10, and FIG. 3 is a diagram of the hand connection position variable device 10 as viewed from an angle different from that of FIG. 2. The hand connection position variable device 10 includes an adapter 26 attached to a tip (here, the wrist 22) of a robot arm, a hand 30 configured to hold a tool 28 configured to allow the robot 12 to perform a predetermined task, a positioning mechanism configured to be capable of alternatively positioning, relative to the adapter 26, the hand 30 in any of at least a first position and a second position described later, and an attaching/detaching mechanism configured to detachably hold the hand 30 relative to the adapter 26.

Note that FIG. 2 illustrates a case in which an automatic tool changer (ATC) is used. Specifically, the adapter (tool adapter) 26 is attached to the wrist 22 via an ATC tool (master cylinder) 32. However, the ATC is not required, and thus the adapter 26 can be attached directly to the wrist 22 and not via the ATC tool 32.

A variety of tools can be used as the tool 28 in accordance with the application of the robot 12. Examples include a gripping-type or an adsorption-type hand, a grinding tool, a welding torch, a needle, a soldering unit, a sealant or paint dispenser, etc. Further, an umbilical member 34 such as a cable or a hose extending from the adapter 26 or the ATC tool 32 for supplying power, pressure, etc., to the tool 28 is connected to the tool 28.

The hand 30 includes a holding member 36 that holds the tool 28 (here, includes a hole through which the tool 28 can be inserted), and a plate-shaped member 38 integrally formed on the holding member 36 and provided with a clamp pin and a positioning pin described later.

The attaching/detaching mechanism in the illustrated example is constituted by a clamp pin 40 having a wedge-shaped tip and provided on the (plate-shaped member 38 of the) hand 30, and a cylinder 42 (refer to FIG. 3) provided to the adapter 26 and configured to retract and detachably grip the clamp pin 40 by air suction, etc. However, the detachable mechanism is not limited to such a configuration, and a gripping (clamping) member such as a clamper may be provided to one of the adapter 26 and the hand 30, and a gripped member may be provided to the other. Note that the attaching/detaching operation of the attaching/detaching mechanism can be automatically performed by the robot controller 24, etc.

The positioning mechanism in the illustrated example is constituted by at least one (four in the illustrated example) positioning pin 44 including a tapered tip and provided to the (plate-shaped member 38 of the) hand 30, and a pin hole 46 (refer to FIG. 3) formed in the adapter 26 and into which each positioning pin 44 can be inserted when the clamp pin 40 is inside the cylinder 42. With insertion of the positioning pin 44 into the pin hole 46, a position and an orientation of the hand 30 (tool 28) relative to the adapter 26 can be brought into a desired state.

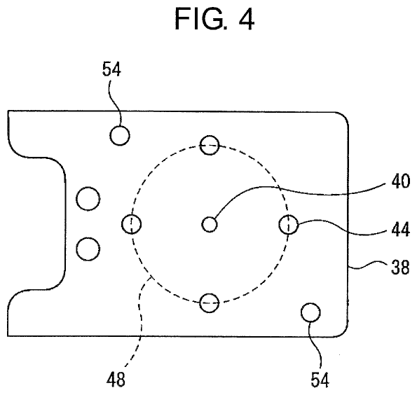

FIG. 4 is a diagram of the hand 30 (plate-shaped member 38) as viewed from above and illustrates the positional relationship between the clamp pin 40 and the positioning pins 44. The positioning pins 44 are disposed on a circumference of a circle 48 with the clamp pin 40 serving as the center, and here four positioning pins are disposed at equal intervals of 90°. Further, as illustrated in FIG. 3, the pin holes 46 of the adapter 26 are provided in the same quantity as and in correspondence with the positions of the positioning pins 44. With the plurality of positioning pins thus disposed at equal intervals on the same circumference, it is possible to change at least one of the position and the orientation of the tool 28 relative to the adapter 26, as described later.

Note that while the position and the orientation of the tool 28 relative to the adapter 26 can be changed in four ways (at 90° increments) in this example, the same is possible even when the number of positioning pins 44 is one and four pin holes 46 are formed as in FIG. 3. However, the greater the number of positioning pins 44, the higher the positioning accuracy of the tool 28 relative to the adapter 26.

While, in the illustrated example, the positioning mechanism is described as including a pin provided to one of the adapter 26 and the hand 30; and a pin hole provided in the other, the positioning mechanism is not limited to that described above. For example, the adapter 26 and the hand 30 may be configured as having a socket-and-spigot joint structure, or complementary tooth shapes such as those of a Curvic coupling may be provided to both the adapter 26 and the hand 30. Preferably, however, the positioning mechanism has a structure such that the tool 28 can be automatically positioned relative to the adapter 26 by the operation of the robot 12 controlled by the robot controller 24, etc.

Next, the operation of changing at least one of the position and the orientation of the tool 28 relative to the adapter 26 will be described. Here, a case is described in which the position and the orientation of the tool 28 relative to the adapter 26 illustrated in FIG. 1 are referred to as a first position, and the tool 28 is changed to a second position, described later, using a temporary placement table 50.

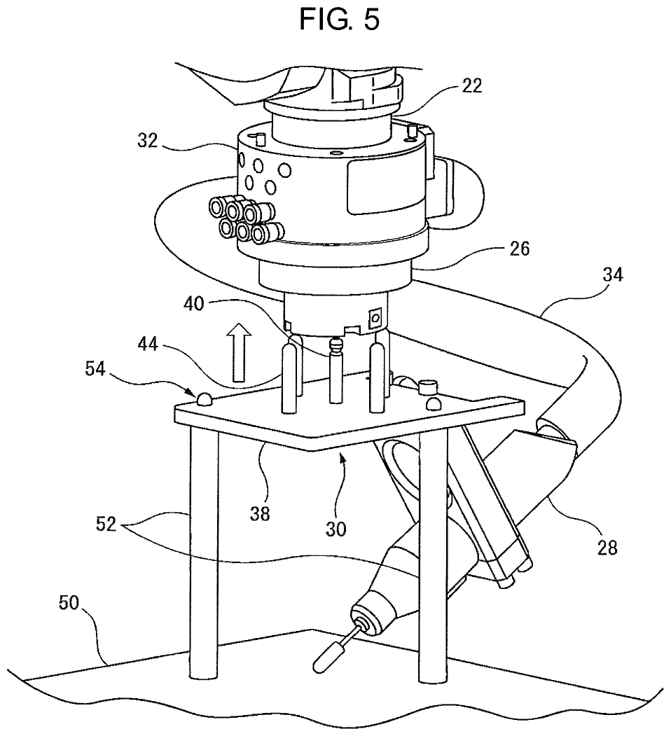

First, as illustrated in FIG. 5, the hand 30 is placed in a predetermined position on the temporary placement table 50 by the operation and control of the robot 12. More specifically, a tip of at least one (two in the example illustrated) positioning rods 52 provided on the temporary placement table 50 is inserted into a rod hole 54 (refer to FIG. 4) formed in the plate-shaped member 38 of the hand 30. This causes the (weight of the) hand 30 to be supported by the temporary placement table 50.

Next, the clamp pin 40 is released from the cylinder 42 and the adapter 26 is moved upward. This operation separates the adapter 26 and the hand 30.

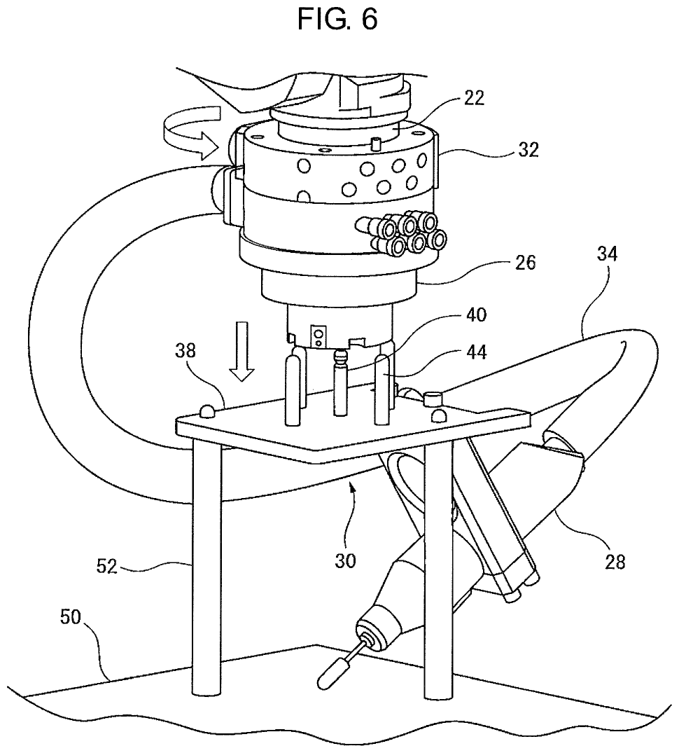

Next, as illustrated in FIG. 6, the wrist 22 of the robot 12 is rotated a predetermined angle (here, 90° counterclockwise) from the state illustrated in FIG. 5, and the adapter 26 is lowered. This operation causes the positioning pins 44 to be inserted into the pin holes 46 while the clamp pin 40 is again retracted into the cylinder 42, and at least one of the position and the orientation of the tool 28 relative to the adapter 26 is to be moved to the second position different from the first position (FIG. 5). Note that, in order to perform these operations, the position and the orientation to which the robot 12 should move are taught to the robotic controller 24 in advance by using a known technique.

In this way, at least one of the position and the orientation of the tool 28 relative to the adapter 26 is changed, thereby changing the position or the orientation (placement/routing) of not only the tool 28, but also the umbilical member 34 connected to the tool 28. Accordingly, when the tool 28 or the umbilical member 34 interferes with a surrounding object, etc., and makes a predetermined task in the first position difficult, by changing the tool 28 to the second position, the predetermined task can be performed without interference. Thus, according to the present embodiment, it is not necessary to prepare a plurality of hands including the same tool with different tool positions or orientations relative to the adapter, making it possible to reduce equipment costs. In addition, since the entire series of operations illustrated in FIG. 5 and FIG. 6 can be performed automatically, the burden on the operator is substantially non-existent, and the cycle time does not change significantly compared to when a tool is replaced by using an ATC, etc.

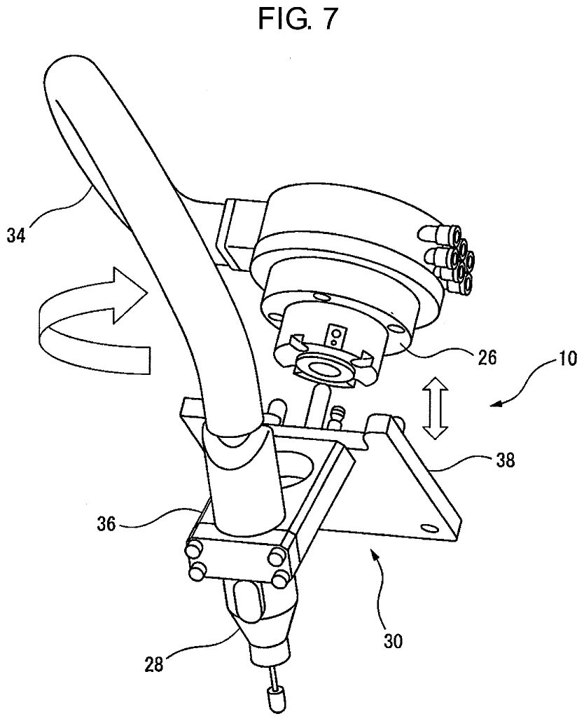

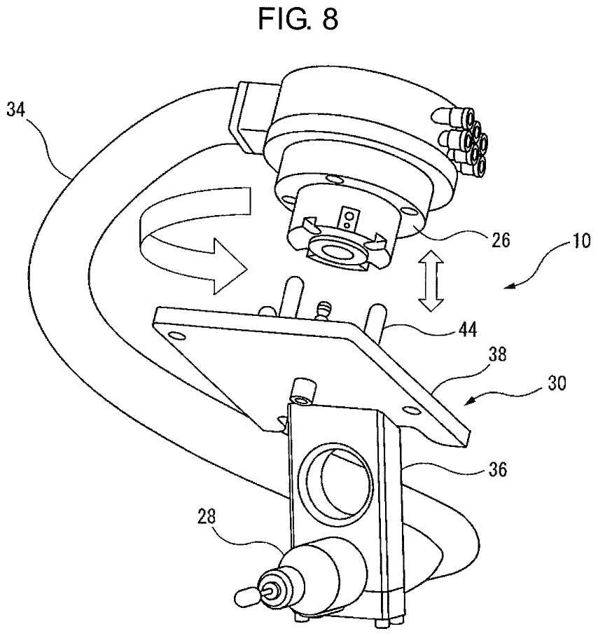

FIG. 7 is a diagram of the hand connection position variable device 10 as viewed from the same angle as that in FIG. 3 but illustrates the adapter 26 rotated 90° clockwise relative to the hand 30 by the same robot operation as the series of operations illustrated in FIG. 5 and FIG. 6. Further, FIG. 8 is a diagram of the hand connection position variable device 10 as viewed from the same angle as that in FIG. 3 but illustrates the adapter 26 rotated 90° counterclockwise relative to the hand 30 by the same robot operation as the series of operations illustrated in FIG. 5 and FIG. 6. As can be seen by comparing FIGS. 3, 7 and 8, even when the same hand 30 is used, the positions and the orientations of the tool 28 and the umbilical member 34 can be greatly changed, making it possible to select the positions and the orientations as appropriate in accordance with the application and thus significantly expand the range of applications that can be supported by the same hand.

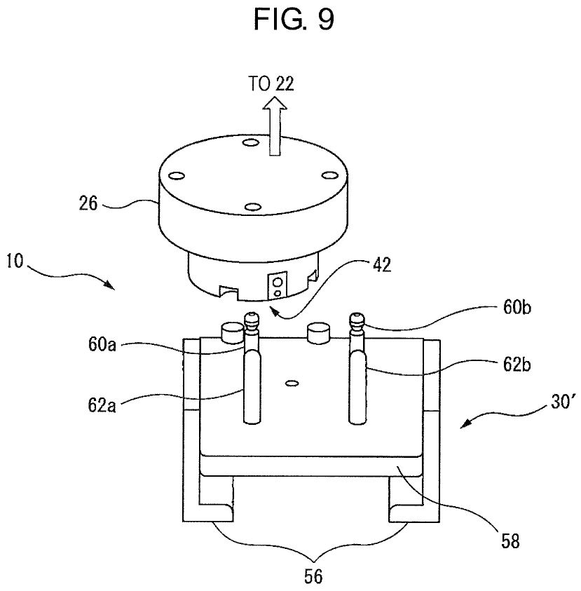

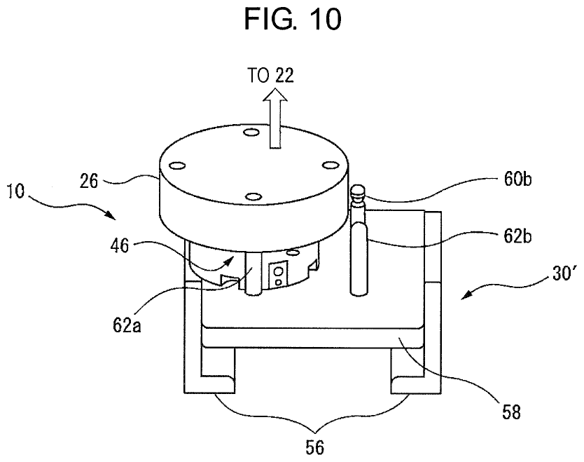

FIG. 9 and FIG. 10 are explanatory drawings of another configuration example of the hand connection position variable device 10. Specifically, in the example of FIG. 2, the hand 30 can be rotationally displaced relative to the adapter 26, whereas a hand 30′ of the present example can be displaced (offset) in one direction relative to the adapter 26.

Specifically, the hand 30′ includes a tool (gripping hand) 56 capable of gripping a workpiece (not illustrated), and a plate-shaped member 58 integrally formed with the hand 56. The plate-shaped member 58 includes a plurality of (two in the illustrated example) clamp pins 60a and 60b each having a wedge shape, and positioning pins 62a and 62b each with a tapered tip and disposed a predetermined distance apart from each of the clamp pins 60a and 60b.

On the other hand, the adapter 26 includes the similar cylinder 42 as in the example in FIG. 2 and FIG. 3 in which the clamp pin 60a or 60b is retracted and detachably gripped by air suction, etc., and the similar pin holes 46 as in the example in FIG. 2 and FIG. 3 in which the positioning pin 62a is insertable when the clamp pin 60a is inside the cylinder 42 and in which the positioning pin 62b is insertable when the clamp pin 60b is inside the cylinder 42. Accordingly, in the present example as well, the clamp pin 60a or 60b and the cylinder 42 constitute the attaching/detaching mechanism, and the positioning pin 62a or 62b and the pin hole 46 constitute the positioning mechanism. Thus, in the example in FIG. 9, with the use of a temporary placement table, etc., in the same manner as in the process in FIG. 5 and FIG. 6, the position of the hand 30′ relative to the adapter 26 can be automatically set and changed to either the first position (when the cylinder 42 holds the clamp pin 60a as in FIG. 10) or the second position (when the cylinder 42 holds the clamp pin 60b).

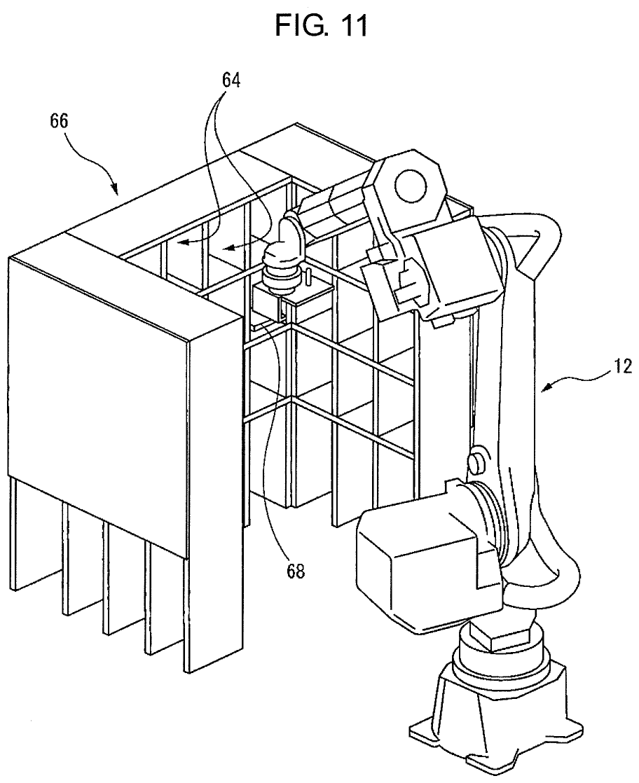

FIG. 11 illustrates an example of a preferred application of the robot 12 provided with the hand connection position variable device 10 in FIG. 9. Here, it is assumed that the robot 12 includes a plurality of storage spaces 64 and is configured to perform an operation in which a workpiece 68 having a plate shape is moved into and out of a rack 66 having a general U-shape in a plan view.

As illustrated in FIG. 11, when the hand 30′ configured to grip the workpiece 68 and store the gripped workpiece 68 on the rack 66 is used, an arm and a fitting thereof (such as the umbilical member 34) may interfere with the rack 66 due to the change in the position and the orientation of the robot (arm) in accordance with the position and the shape of the rack 66 (storage space 64). In the prior art, in order to avoid interference, the rack needs to be designed so that interference does not occur with the various orientations of the robot, which tends to increase the size of the rack. Furthermore, in order to carry out such a design, the orientations to be acquired by the robot need to be found in advance by simulation, etc., requiring time and effort.

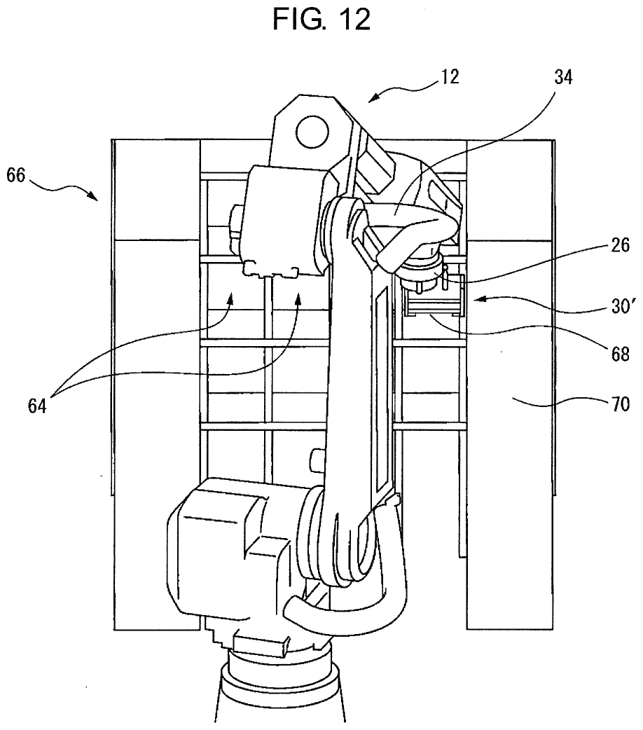

Here, with the use of such a hand connection position variable device 10 as illustrated in FIG. 9, the above-described defects can be resolved. For example, as illustrated in FIG. 12, when the hand 30′ is shifted to the right side relative to the adapter 26 (refer to FIG. 10), the adapter 26 is shifted to the left side relative to the workpiece 68, and thus interference of the umbilical member 34, etc., with a right side portion 70 of the rack 66 can be avoided. In this manner, when the robot enters a relatively narrow region and performs a task, the positional relationship between the adapter and the hand is (automatically) changed in advance to an appropriate one, making it possible to eliminate the inconvenience of the robot interfering with a surrounding object, etc., and not being able to perform the task (thus requiring preparation of other hands, etc.).

According to the embodiment described above, even when the robot cannot access the task target, the location or the orientation (angle) of the tool relative to the adapter may be selected and changed, making the task target accessible. In addition, even when the workpiece held by the robot may interfere with a surrounding object, etc., interference can be avoided by appropriately selecting the position or the orientation of the tool relative to the adapter. Furthermore, while a fitting, etc., of the robot may interfere with a surrounding object depending on the operation orientation of the robot, it is possible to teach a robot operation in which interference does not occur by changing the position or the orientation of the tool relative to the adapter. In this way, a plurality of relative positional relationships between the adapter and the tool can be realized by detaching only the hand from the adapter, changing the angle and the position of the tool relative to the adapter, and subsequently attaching the hand to the adapter once again, making it possible to expand the operating range of the robot hand and avoid interference that cannot be avoided by operation of the robot alone. Accordingly, in the present disclosure, the need to prepare and fabricate a plurality of hands that differ only in the positional relationship with the adapter can be minimized as much as possible, and equipment costs can be suppressed.

According to the present disclosure, one or both of the position and the orientation of the tool relative to the adapter can be easily changed, making it possible to avoid interference between the robot and a surrounding object, etc., and reduce the need for providing various types of tools.

While the invention has been described with reference to specific embodiments chosen for the purpose of illustration, it should be apparent that numerous modifications could be made thereto, by a person skilled in the art, without departing from the basic concept and scope of the invention.

1. A hand connection position variable device comprising:
an adapter attached to a movable part of a robot;
a hand configured to hold a tool configured to allow the robot to perform a predetermined task;
a positioning mechanism configured to be capable of positioning, relative to the adapter, the hand in any of a plurality of positions including a first position and a second position that has at least one of a position and an orientation of the tool relative to the adapter being different from that of the first position; and
an attaching/detaching mechanism configured to detachably hold, relative to the adapter, the hand positioned by the positioning mechanism.

2. The hand connection position variable device according to claim 1, wherein
the attaching/detaching mechanism includes a clamp pin provided to the hand, and a cylinder that is provided to the adapter and is configured to detachably hold the clamp pin, and
the positioning mechanism includes at least one positioning pin provided to the hand and disposed on a circumference with the clamp pin serving as a center, and a pin hole that is provided to the adapter and is configured to allow the positioning pin to be inserted therein.

3. The hand connection position variable device according to claim 1, wherein
the attaching/detaching mechanism includes a plurality of clamp pins provided, spaced apart from each other, to the hand, and a cylinder that is provided to the adapter and is configured to detachably hold any one of the plurality of clamp pins, and
the positioning mechanism includes a positioning pin provided to the hand and disposed a predetermined distance away from each of the plurality of clamp pins, and a pin hole that is provided to the adapter and is configured to allow the positioning pin to be inserted therein.

4. The hand connection position variable device according to claim 1, wherein the attaching/detaching mechanism is configured to operate automatically.

5. A robot comprising:
the hand connection position variable device of claim 1; and
the movable part.

6. The robot according to claim 5 configured to automatically perform:
an operation of detaching the hand from the adapter by the attaching/detaching mechanism,
an operation of moving the adapter relative to the hand, causing the hand detached from the adapter to be positioned in the first position or the second position, and
an operation of holding, by the attaching/detaching mechanism, the hand positioned.
